(19) United States
(12) Patent Application Publication
(10) Pub. No.: US 2023/0089044 A1
(43) Pub. Date: Mar. 23, 2023

(54) OPTICAL CONNECTOR

(71) Applicant: NITTO DENKO CORPORATION, Osaka (JP)

(72) Inventors: Naoto KONEGAWA, Osaka (JP); Seiki TERAJI, Osaka (JP); Kouji ICHINOSE, Osaka (JP)

(73) Assignee: NITTO DENKO CORPORATION, Osaka (JP)

(21) Appl. No.: 17/913,745

(22) PCT Filed: Mar. 26, 2021
(86) PCT No.: PCT/JP2021/012812

§ 371 Date: Sep. 22, 2022

(30) Foreign Application Priority Data
Mar. 27, 2020 (JP) 2020-057261

(51) Int. Cl. G02B 6/38

(52) U.S. Cl. CPC G02B 6/382; G02B 6/3853; G02B 6/3861

(57) ABSTRACT

Provided is an optical connector that includes a ferrule and an optical fiber as a plastic optical fiber. The ferrule has a leading end face and a through hole for holding a fiber, the through hole having an opening end in the leading end face. The optical fiber has a leading end. The leading end of the optical fiber is inserted in the through hole and located at a retraction position retracted from the leading end face.

### TECHNICAL FIELD

The present invention relates to an optical connector.

### BACKGROUND ART

In an optical communication network, an optical connector may be used for optical connection between optical fibers that constitute an optical transmission line. The optical connector includes, for example, a ferrule having a through hole for holding a fiber, and an optical fiber of which a leading end portion is inserted into the through hole to thereby be held by the ferrule.

In the optical connection using the optical connector, conventionally leading ends of both optical fibers to be connected are abutted against each other, so that the optical fibers are brought into close contact with each other, thereby reducing connection loss at the connecting point between the fibers. To achieve a good close contact between the optical fibers by such abutment, the leading end of the optical fiber needs to be polished to trim the shape or the like of the leading end of the optical fiber in a production process of the optical connector. In the production process of the optical connector, for example, in a state where the optical fiber and the ferrule are assembled so that the leading end of the optical fiber is exposed at a ferrule leading end face, the leading end of the optical fiber is polished together with the ferrule leading end face. A technique for polishing the leading end of the optical fiber held by the ferrule together with the ferrule leading end face is disclosed in, for example, Patent Documents 1 and 2.

### CITATION LIST

### Patent Document

Patent Document 1: Japanese Unexamined Patent Publication No. 2004-264708

Patent Document 2: Japanese Unexamined Patent Publication No. 2011-104770

### SUMMARY OF THE INVENTION

### Problem to be Solved by the Invention

However, it is not desirable to require such a polishing step in the production process of the optical connector in view of the cost of producing the optical connector.

When the polishing step is performed, a polishing liquid used in this step may remain adhered to the optical connector as a residue even after a subsequent cleaning step, so that the optical connector may be contaminated. This contamination leads to an increase in transmission loss in the optical connector, which is not desirable.

In addition, the above-described abutment of the leading ends of the optical fibers against each other can cause damage to the optical fiber leading ends, including occurrence of cracks in the leading ends of the optical fibers.

The present invention provides an optical connector suitable for being produced without the polishing step and suitable for suppressing damage to the optical fiber leading ends.

### Means for Solving the Problem

The present invention [1] includes an optical connector including a ferrule having a leading end face and a through hole for holding a fiber, the through hole having an opening end in the leading end face; and a plastic optical fiber having a fiber leading end that is inserted in the through hole and located at a retraction position retracted from the leading end face.

The optical connector of this configuration is suitable for achieving an optical connection between optical fibers without abutting the optical fiber leading ends against each other, and is therefore suitable for producing the optical connector without the above-described polishing step of polishing the leading end of the optical fiber held by the ferrule, together with the ferrule leading end face. The optical connector suitable for being produced without the polishing step is suitable for reducing the cost of producing the optical connector, and is also suitable for suppressing contamination of the optical connector to reduce transmission loss. In addition, this optical connector suitable for achieving the optical connection between the optical fibers without abutting the optical fiber leading ends against each other is suitable for suppressing damage to the optical fiber leading ends.

The present invention [2] includes the optical connector described in [1], in which a length of the retraction is 1 μm or more and 1000 μm or less.

This configuration is suitable for suppressing increase in transmission loss in an optical connection between optical fibers without abutment of their leading ends against each other.

The present invention [3] includes the optical connector described in [1] or [2], further including an index matching material that is opposed to the opening end.

In this optical connector, this configuration is suitable for achieving an optical connection between optical fibers without abutment of their leading ends against each other while suppressing increase in transmission loss.

The present invention [4] includes the optical connector described in any one of the above-described [1] to [3], further including a lens portion that is opposed to the opening end.

In this optical connector, this configuration is suitable for achieving an optical connection between optical fibers without abutment of their leading ends against each other while suppressing increase in transmission loss.

The present invention [5] includes the optical connector described in any one of the above-described [1] to [4], further including an adhesive that is cured to fix the plastic optical fiber in the through hole, the adhesive having a viscosity before curing of 0.5 Pa·s or more and 20 Pa·s or less.

In the production process of this optical connector, when the adhesive is supplied to the through hole in which the optical fiber leading end portion has already been inserted, this configuration is suitable for suppressing dripping of the adhesive from the through hole to the leading end face side of the ferrule, and is therefore suitable for suppressing contamination of the ferrule leading end face.

The present invention [6] includes the optical connector described in any one of the above-described [1] to [5], in which the plastic optical fiber is a refractive index distribution type plastic optical fiber.

This configuration is suitable for transmitting an optical signal in multimode at this optical connector.

### BRIEF DESCRIPTION OF THE DRAWINGS

FIG. 1 is a perspective view of one embodiment of an optical connector according to the present invention.

FIG. 2 is a plan view of the optical connector shown in FIG. 1.

FIG. 3 is a cross-sectional view of the optical connector shown in FIG. 2, taken along line

FIG. 4 is a cross-sectional view of the optical connector shown in FIG. 2, taken along line IV-IV.

FIG. 5 is a perspective view of a ferrule in the optical connector shown in FIG. 1.

FIG. 6 is a vertical cross section of the ferrule in the optical connector shown in FIG. 1.

FIGS. 7A to 7C illustrate a method for producing the optical connector shown in FIG. 1: FIG. 7A illustrates a preparation step, FIG. 7B illustrates a fiber insertion step, and FIG. 7C illustrates an adhesive filling step.

FIG. 8 is a plan view of a modification of the optical connector according to the present invention.

FIG. 9 is a cross-sectional view of the optical connector shown in FIG. 8, taken along line IX-IX.

FIG. 10 is a plan view of another modification of the optical connector according to the present invention.

FIG. 11 is a cross-sectional view of the optical connector shown in FIG. 10, taken along line XI-XI.

FIG. 12 is a plan view of another modification of the optical connector according to the present invention.

FIG. 13 is a cross-sectional view of the optical connector shown in FIG. 12, taken along line XIII-XIII.

### DESCRIPTION OF THE EMBODIMENTS

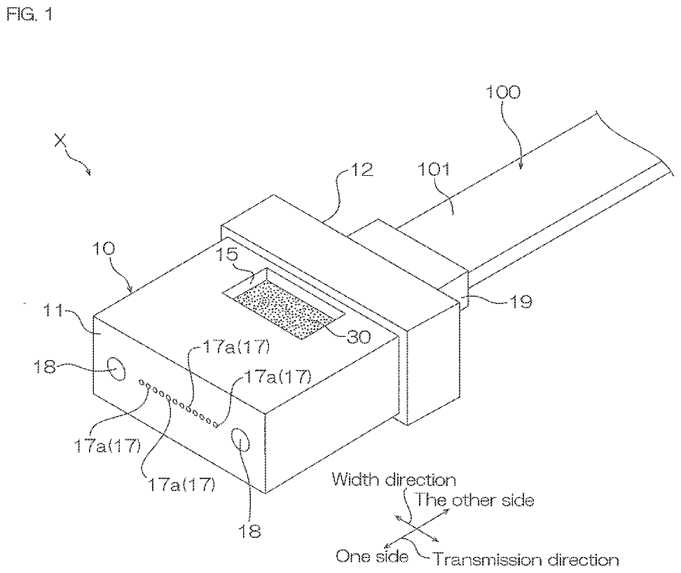

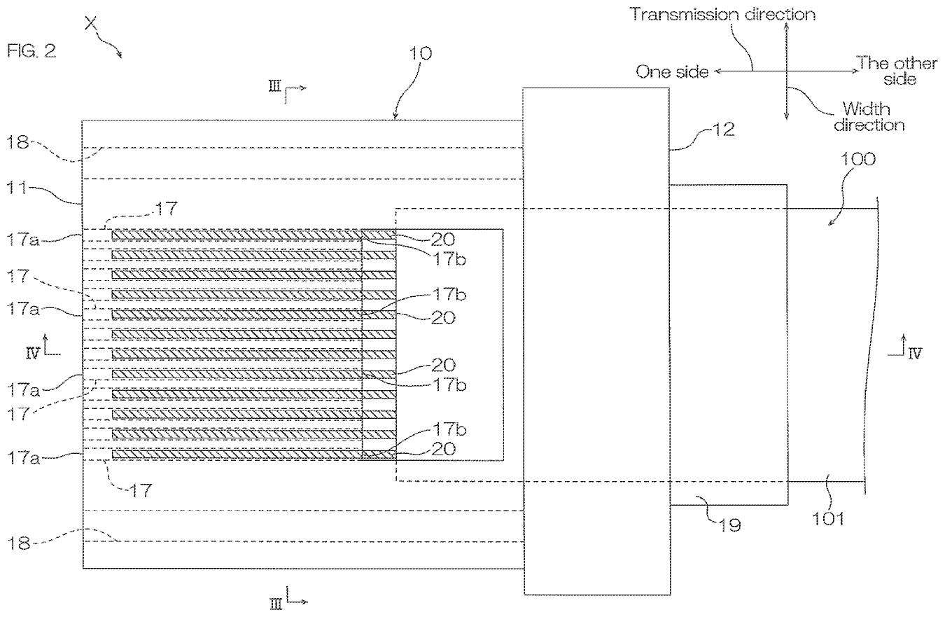

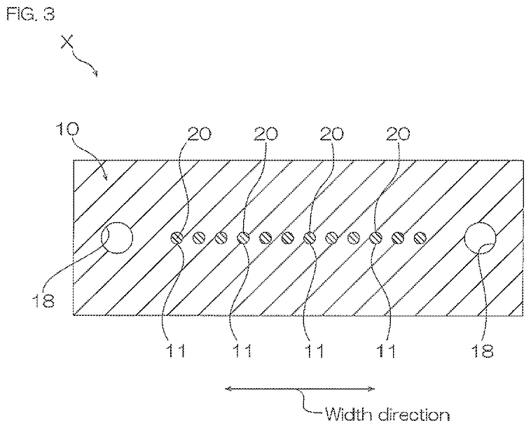

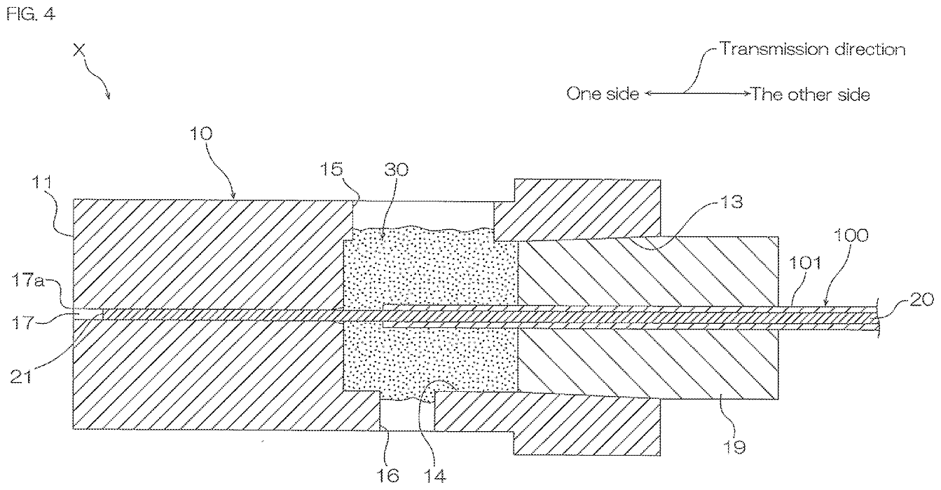

FIGS. 1 to 4 show an optical connector X according to one embodiment of the present invention. FIG. 1 is a perspective view of the optical connector X. FIG. 2 is a plan view of the optical connector X (in FIG. 2, an adhesive 30 to be described later is omitted). FIG. 3 is a cross-sectional view of the optical connector X shown in FIG. 2, taken along line III-III. FIG. 4 is a cross-sectional view of the optical connector X shown in FIG. 2, taken along line IV-IV.

In the present embodiment, the optical connector X is a multi-core MT connector provided at one end of a multi-core optical fiber cable 100 that constitutes a signal transmission line, and includes a ferrule 10 and a plurality of optical fibers 20.

The ferrule 10 is a member that holds a leading end portion of the optical fiber 20, and has a leading end face 11 on one side in a transmission direction of a signal and a rear end face 12 on the other side in the transmission direction of the signal. The ferrule 10 also has a flat tube shape having a predetermined thickness, and an introduction port 13, a hollow portion 14, a filling port 15, a vent hole 16, a plurality of through holes 17, and two guide holes 18.

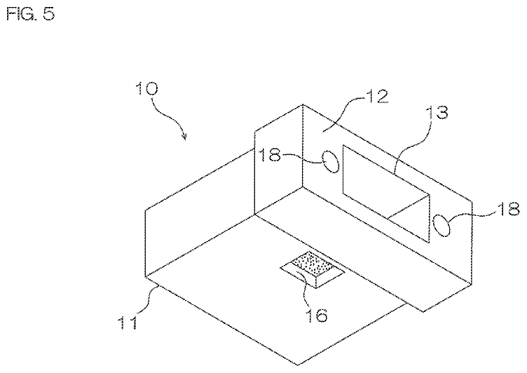

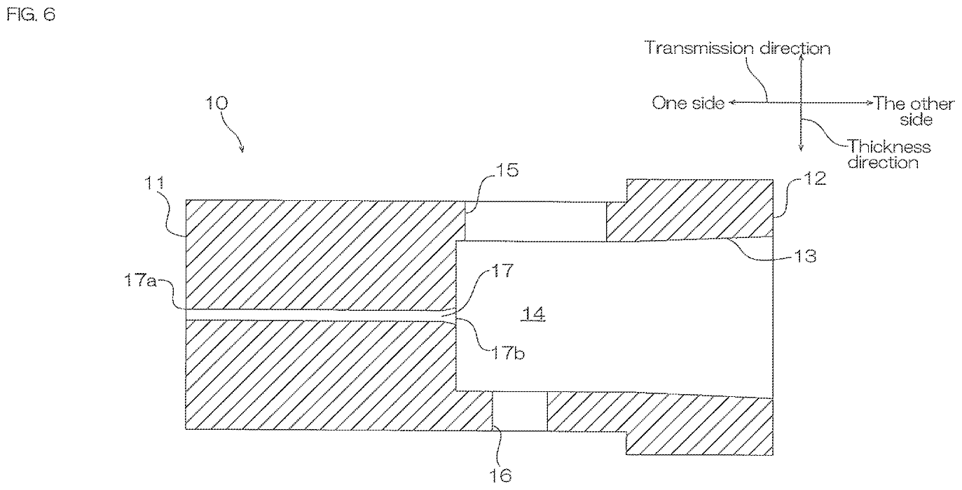

The introduction port 13 is an opening for introducing the optical fiber 20 into the ferrule 10, and opens at the rear end face 12 of the ferrule 10 as shown in FIGS. 5 and 6.

The hollow portion 14 is disposed on the leading end face 11 side from the introduction port 13 and communicates with the introduction port 13. The hollow portion 14 is a space to be filled with an adhesive, and communicates with the filling port 15, the vent hole 16, and the through hole 17 as clearly shown in FIG. 5. The filling port 15 is an opening for supplying an adhesive to the hollow portion 14. The vent hole 16 is a ventilation passage for allowing air to escape from the hollow portion 14 to the outside of the ferrule 10 during supplying of the adhesive to the hollow portion 14. In the present embodiment, the filling port 15 and the vent hole 16 are opposed to each other with the hollow portion 14 interposed therebetween in a thickness direction.

The through hole 17 is a hole for holding a fiber, and for example, as shown in FIGS. 2 and 6, extends in the transmission direction of the signal and has one opening end 17a that opens at the leading end face 11 of the ferrule 10 and the other opening end 17b that connects to the hollow portion 14. The diameter of the through hole 17 (cross-sectional diameter of the through hole shown in FIG. 3) is a size corresponding to the diameter of the optical fiber 20 to be held (a size allowing the optical fiber 20 to be inserted). The plurality of through holes 17 are arranged in parallel in a width direction (a direction orthogonal to the transmission direction and the thickness direction; the same applies hereinafter) of the ferrule 10, and are aligned in a row in the present embodiment.

The guide hole 18 is a hole for allowing a guide pin (not illustrated) to be fitted thereinto. As shown in FIGS. 1 and 2, two guide holes 18 are spaced apart in the width direction with the introduction port 13 and the plurality of through holes 17 sandwiched therebetween, and in the present embodiment, the holes open at the leading end face 11 and open at the rear end face 12. The through holes 17 are arranged in parallel between the two guide holes 18.

The ferrule 10 is, for example, a resin molded article. Examples of the constituent material of the resin molded article include polyphenylene sulfide and polyetherimide. This constituent material may contain a filler such as silica particles.

The optical fiber 20 constitutes a part of the optical fiber cable 100 in the present embodiment, and is held by the ferrule 10. The optical fiber cable 100 has the plurality of optical fibers 20 and a cable jacket 101 that covers the optical fibers 20. The optical fibers 20 are exposed from the cable jacket 101 at the leading end portion of the optical fiber cable 100. The optical fiber cable 100, or the optical fibers 20, in such form are held by being inserted in the introduction port 13, the hollow portion 14, and the through hole 17 in the ferrule 10. Specifically, in a state where the optical fiber cable 100 is covered with a boot member 19, the boot member 19 is fitted in the introduction port 13, the optical fiber cable 100, or the optical fibers 20, are fixed in the hollow portion 14 by the cured adhesive 30, and the plurality of optical fibers 20 are each inserted into each through hole 17 and are fixed in the through hole 17 by the cured adhesive 30 (not illustrated).

Each optical fiber 20 has a leading end 21 as shown in FIGS. 2 and 4. The leading end 21 is, for example, cut out to be flat and perpendicular to an optical axis of the optical fiber 20. In the ferrule 10, the leading end 21 of the optical fiber 20 is inserted into the through hole 17 and located at a retraction position that is retracted from the leading end face 11 to the inside of the ferrule 10 (toward the other side in the transmission direction).

The length of the retraction of the leading end 21 from the leading end face 11 of the ferrule 10 is preferably 1 μm or more, more preferably 3 μm or more, more preferably 5 μm or more. This configuration is suitable for protecting the leading end 21 of the optical fiber 20. The length of the retraction of the leading end 21 from the leading end face 11 of the ferrule 10 is preferably 1000 μm or less, more preferably 100 μm or less, more preferably 50 μm or less. This configuration is suitable for reducing transmission loss in an optical connection between optical fibers without abutment of their leading ends against each other.

The optical fiber 20 is a plastic optical fiber and includes a core having a relatively high refractive index and constitutes an optical transmission line itself, and a clad having a relatively low refractive index and located around the core to extend along the core. Examples of the constituent material of the core include a resin material having flexibility such as polymethyl methacrylate and polycarbonate. Examples of the constituent material of the clad include a fluorine-containing polymer such as fluorine-containing polyimide.

The optical fiber 20 is preferably a refractive index distribution type plastic optical fiber. This configuration is suitable for transmitting an optical signal in multimode at the optical connector X.

Examples of the adhesive 30 include a liquid curable composition containing a curable resin. Examples of the curable resin include a thermosetting resin that can be cured by heating and a photocurable resin that can be cured by irradiation with light.

Examples of the curable resin include epoxy resin, silicone resin, urethane resin, polyimide resin, urea resin, melamine resin, and unsaturated polyester resin. These may be used alone or in combination of two or more kinds.

Examples of the epoxy resin include bifunctional epoxy resins and polyfunctional epoxy resins, such as a bisphenol A type epoxy resin, a bisphenol F type epoxy resin, a bisphenol S type epoxy resin, a brominated bisphenol A type epoxy resin, a hydrogenated bisphenol A type epoxy resin, a bisphenol AF type epoxy resin, a biphenyl type epoxy resin, a naphthalene type epoxy resin, a fluorene type epoxy resin, a phenol novolak type epoxy resin, an o-cresol novolak type epoxy resin, a tris(hydroxyphenyl)methane type epoxy resin, and a tetraphenylolethane type epoxy resin. Examples of the epoxy resin also include a hydantoin type epoxy resin, a triglycidyl isocyanurate type epoxy resin, and a glycidyl amine type epoxy resin. These may be used alone or in combination of two or more kinds.

Examples of the silicone resin include straight silicone resins such as methyl silicone resin, phenyl silicone resin, and methyl phenyl silicone resin. Examples of the silicone resin also include modified silicone resins such as alkyd-modified silicone resin, polyester-modified silicone resin, urethane-modified silicone resin, epoxy-modified silicone resin, and acryl-modified silicone resin. These may be used alone or in combination of two or more kinds.

When the curable composition is an epoxy resin composition containing an epoxy resin, the curable composition may further contain a curing agent. Examples of the curing agent include an imidazole compound and an amine compound. The curable composition may contain, for example, a curing accelerator such as a urea compound, a tertiary amine compound, a phosphorus compound, a quaternary ammonium salt compound, and an organic metal salt compound.

When the curable resin has photocurability, the curable composition may contain, for example, a photopolymerization initiator.

The curable composition may contain a filler. Examples of the filler include inorganic fillers such as aluminum hydroxide, magnesium hydroxide, calcium carbonate, magnesium carbonate, quartz glass, talc, silica, aluminum nitride, silicon nitride, and boron nitride; and organic fillers such as acrylic resin particles, and silicone resin particles.

The curable composition may contain an additive such as a thermoplastic resin (acrylic resin, etc.), a coupling agent, or a lubricant in an appropriate content ratio.

The content ratio of the curable resin in the curable composition is, for example, 50% by mass or more, and for example, 90% by mass or less. The content ratio of the curing agent in the curable composition is, for example, 1% by mass or more, and for example, 40% by mass or less. The content ratio of the curing accelerator in the curable composition is, for example, 0.5% by mass or more, and for example, 10% by mass or less. The content ratio of the filler in the curable composition is, for example, 1% by mass or more, and for example, 40% by mass or less.

The adhesive 30 (curable composition) before curing has a viscosity at 25° C. of preferably 0.5 Pa·s or more, more preferably 1.0 Pa·s or more, and preferably 20 Pa·s or less, more preferably 10 Pa·s or less, even more preferably 5 Pa·s or less. The viscosity of the adhesive 30 can be measured by, for example, an EHD type viscometer.

As the adhesive 30, commercially available products can be used and for example, Z-591-Y4 manufactured by Aica Kogyo Co., Ltd., Z-591-Y6 manufactured by Aica Kogyo Co., Ltd., 3553-HM manufactured by EMI Ltd., and 8776-LS1 manufactured by Kyoritsu Chemical & Co., Ltd. can be used.

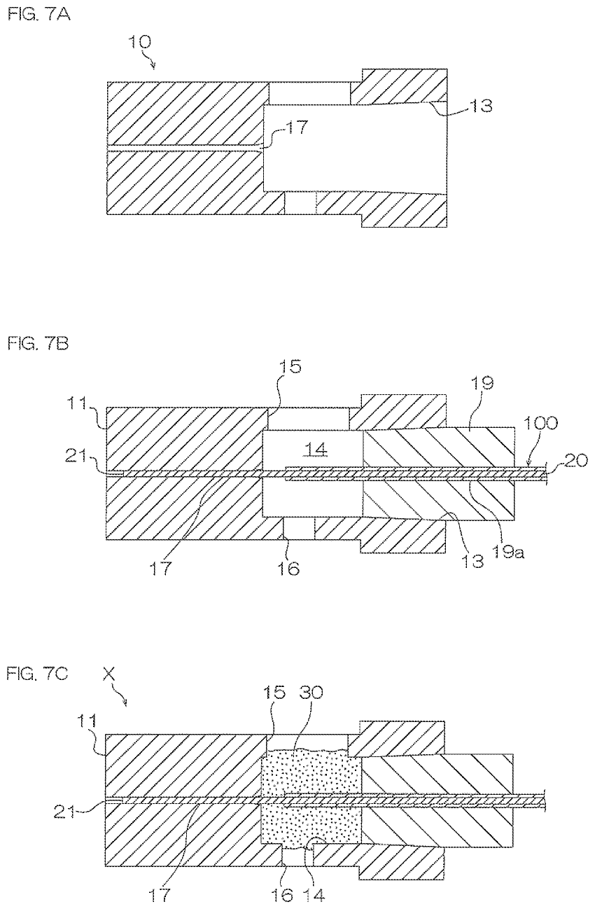

FIG. 7 illustrates a method for producing the optical connector X.

In the production of the optical connector X, first, as shown in FIG. 7A, the ferrule 10 is prepared. The optical fiber cable 100 having the plurality of optical fibers 20 exposed by a predetermined length from a leading end thereof is also prepared.

Then, as shown in FIG. 7B, the optical fiber cable 100 is inserted into the ferrule 10. In the present embodiment, in a state where the optical fiber cable 100 is inserted through an opening 19a of the boot member 19, the optical fiber cable 100 is inserted into the ferrule 10 from the introduction port 13, and each of the optical fibers 20 at the leading end of the optical fiber cable 100 is inserted into the through hole 17 of the ferrule 10. The optical fiber 20 is inserted into the through hole 17 to a position where the leading end 21 of the optical fiber 20 is retracted from the leading end face 11 of the ferrule 10 by a predetermined length. Then, the boot member 19 is fitted in the introduction port 13 of the ferrule 10.

Next, as shown in FIG. 7C, the adhesive 30 is filled into the hollow portion 14 through the filling port 15 of the ferrule 10. When the hollow portion 14 is filled with the adhesive 30, the adhesive 30 also penetrates between an inner wall surface of the through hole 17 and the optical fiber 20 in the through hole 17 to thereby be supplied therebetween (the adhesive 30 is not illustrated). After filling, the adhesive 30 is cured. Specifically, when the adhesive 30 contains a thermosetting resin as the curable component, the adhesive 30 is cured by heating. When the adhesive 30 contains a photocurable resin as the curable component, the adhesive 30 is cured by irradiation of light. In the manner described above, the optical connector X can be produced.

In the optical connector X, as described above, the leading end 21 of the optical fiber 20 that is inserted in the through hole 17 in the ferrule 10 is located at a retraction position retracted from the leading end face 11 of the ferrule 10. This configuration is suitable for achieving an optical connection between optical fibers without abutting the optical fiber leading ends against each other in an optical connection to the other optical connector, and is therefore suitable for producing the optical connector X without a step of polishing the leading end 21 of the optical fiber 20 held by the ferrule 10, together with the leading end face 11 of the ferrule 10. The optical connector X suitable for being produced without such a polishing step is suitable for reducing the cost of producing the optical connector, and is also suitable for suppressing contamination (contamination caused by a polishing liquid used in the polishing step) of the optical connector X to reduce transmission loss. In addition, the optical connector X suitable for achieving the optical connection between the optical fibers without abutting the optical fiber leading ends against each other is suitable for suppressing damage to the optical fiber leading ends.

In the optical connector X, as described above, the length of the retraction of the leading end 21 of the optical fiber 20 from the leading end face 11 of the ferrule 10 is preferably 1 μm or more, more preferably 3 μm or more, more preferably 5 μm or more, and is preferably 1000 μm or less, more preferably 100 μm or less, more preferably 50 μm or less. This configuration is suitable for reducing transmission loss in the optical connection between the optical fibers without abutment of their leading ends against each other while protecting the optical fiber leading ends.

As described above, the adhesive 30 before curing in the optical connector X has a viscosity at 25° C. of preferably 0.5 Pa·s or more, more preferably 1.0 Pa·s or more, and preferably 20 Pa·s or less, more preferably 10 Pa·s or less, even more preferably 5 Pa·s or less. In a production process of the optical connector X, when the adhesive 30 is supplied to the through hole 17 in which the leading end 21 of the optical fiber 20 has already been inserted, this configuration is suitable for suppressing dripping of the adhesive 30 from the through hole 17 to the leading end face 11 side of the ferrule 10, and is therefore suitable for suppressing contamination of the leading end face 11.

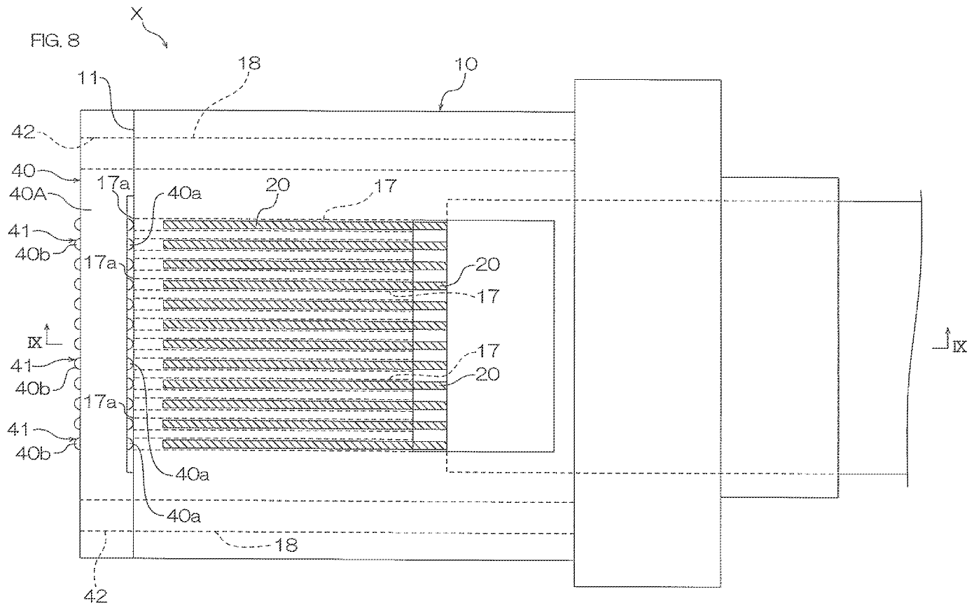

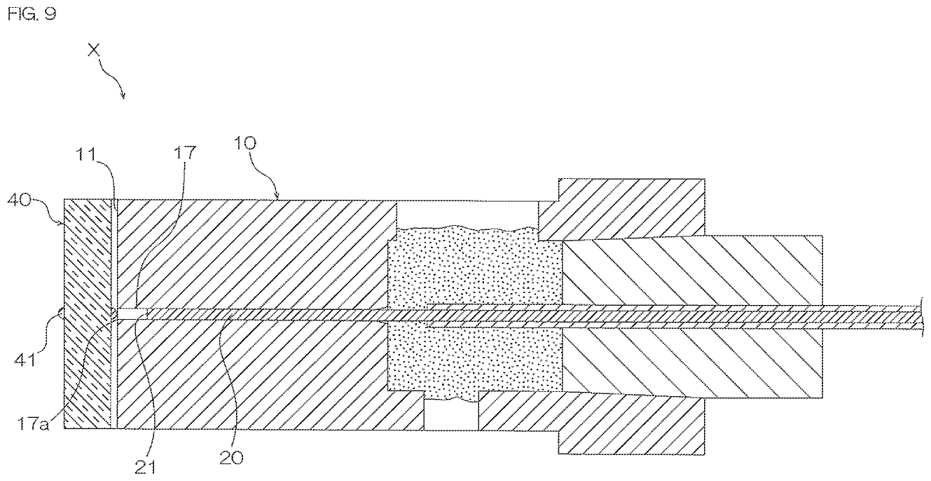

As shown in FIGS. 8 and 9, the optical connector X may further include a lens array 40 that is opposed to the leading end face 11 of the ferrule 10 (in FIG. 8, the above-described adhesive 30 is omitted).

The lens array 40 includes a plurality of lens portions 41. Specifically, the lens array 40 has an array plate 40A, a plurality of convex lens-shaped portions 40a disposed on the ferrule 10 side of the array plate 40A, and a plurality of convex lens-shaped portions 40b disposed on an opposite side to the ferrule 10 side of the array plate 40A. Each of the convex lens-shaped portions 40b is disposed corresponding to each of the convex lens-shaped portions 40a. One lens portion 41 is constituted with a pair of convex lens-shaped portions 40a and 40b and a portion of the array plate 40A interposed therebetween. Each of the lens portions 41 is opposed to the opening end 17a of the through hole 17 in the ferrule 10 and has a lens shape that exhibits a light condensing function in the optical connection for the leading end 21 of the optical fiber 20 in the through hole 17.

The lens array 40 has two guide holes 42. The two guide holes 42 are provided at positions corresponding to two guide holes 18 opening in the leading end face 11 of the ferrule 10. The guide hole 42 and the guide hole 18 have the same size (diameter).

The lens array 40 is, for example, a molded article of transparent resin material. Examples of the resin material include glass, cycloolefin polymer (COP), polymethyl methacrylate, and polystyrol.

The lens array 40 is bonded to the leading end face 11 of the ferrule 10 through a predetermined adhesive while the guide hole 18 and the guide hole 42 are aligned with each other. Alternatively, such adhesive bonding is not made, but the lens array 40 may be assembled with the ferrule 10 by fitting a guide pin (not illustrated) into the guide hole 18 of the ferrule 10 and the guide hole 42 of the lens array 40 as well.

In the optical connector X, the configuration of this modification in which the optical connector X is equipped with the lens array 40 including the lens portion 41 having the light condensing function is suitable for achieving the optical connection between the optical fibers without abutment of their leading ends against each other while suppressing increase in transmission loss.

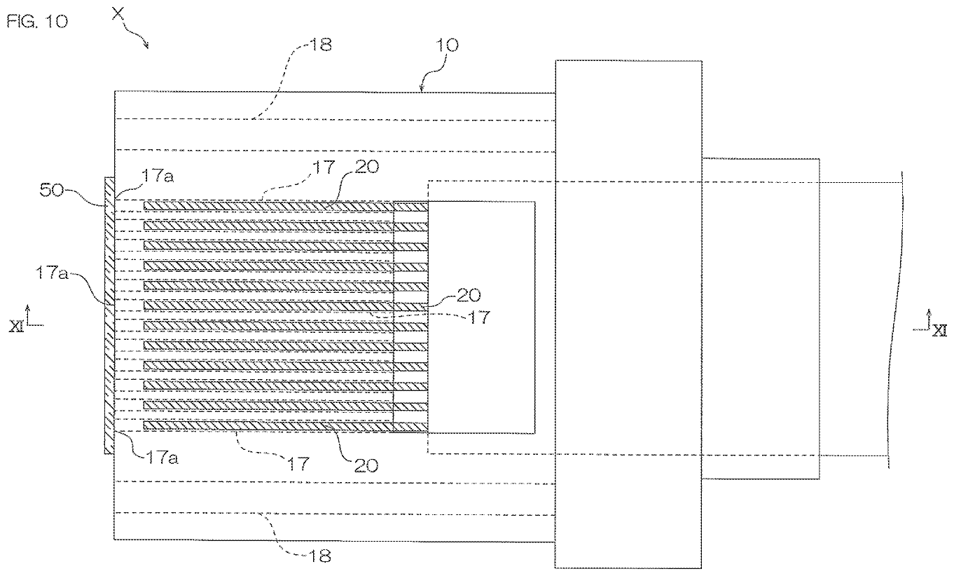

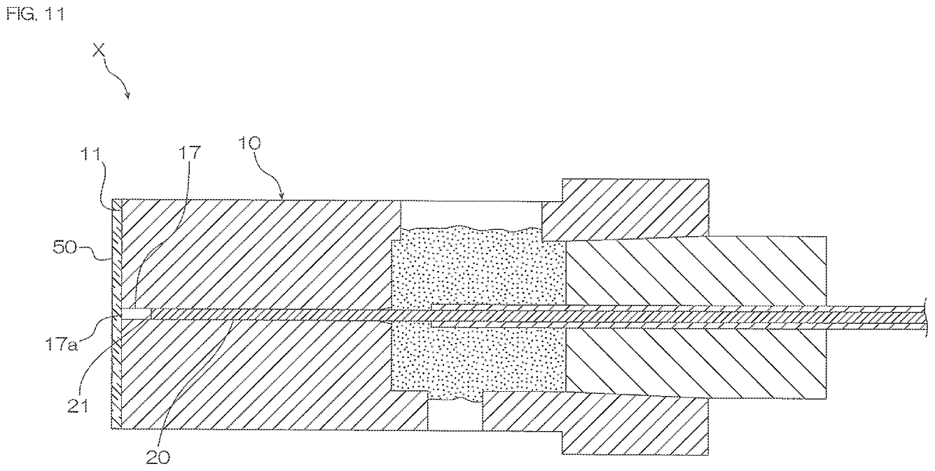

As shown in FIGS. 10 and 11, the optical connector X may further include an index matching material 50 that is disposed on the leading end face 11 of the ferrule 10 (in FIG. 10, the above-described adhesive 30 is omitted).

The index matching material 50 is opposed to all the opening ends 17a of the plurality of through holes 17 in the ferrule 10, and constitutes a region having a predetermined refractive index on the optical axis of the optical fiber 20 held by each through hole 17. The refractive index of the index matching material 50 is set equal to or almost equal to the refractive index of the optical fiber 20, and the index matching material 50 exhibits a function of suppressing light diffusion in the optical connection for the leading end 21 of the optical fiber 20. As the index matching material 50, a liquid index matching material may be used, or a solid index matching material may be used. Examples of the liquid index matching material include index matching materials formed from a thermosetting or ultraviolet curable, silicone or acrylic polymer material. Examples of the liquid index matching material also include index matching materials formed from a water-organic solvent mixed solution. These liquid index matching materials may function as an adhesive in the optical connector X. Examples of the solid index matching material include index matching materials formed from an acrylic, epoxy, vinyl, silicone, rubber, urethane, methacrylic, nylon, bisphenol, diol, polyimide, fluorinated epoxy, or fluorinated acrylic polymer material. The index matching material 50 is, for example, in the form of a film, and is laminated to the leading end face 11 of the ferrule 10 through a predetermined adhesive or using a self-adhesive force of the index matching material film.

In the optical connector X, the configuration of this modification in which the optical connector X is equipped with the index matching material 50 having an index matching function is suitable for achieving the optical connection between the optical fibers without abutment of their leading ends against each other while suppressing increase in transmission loss.

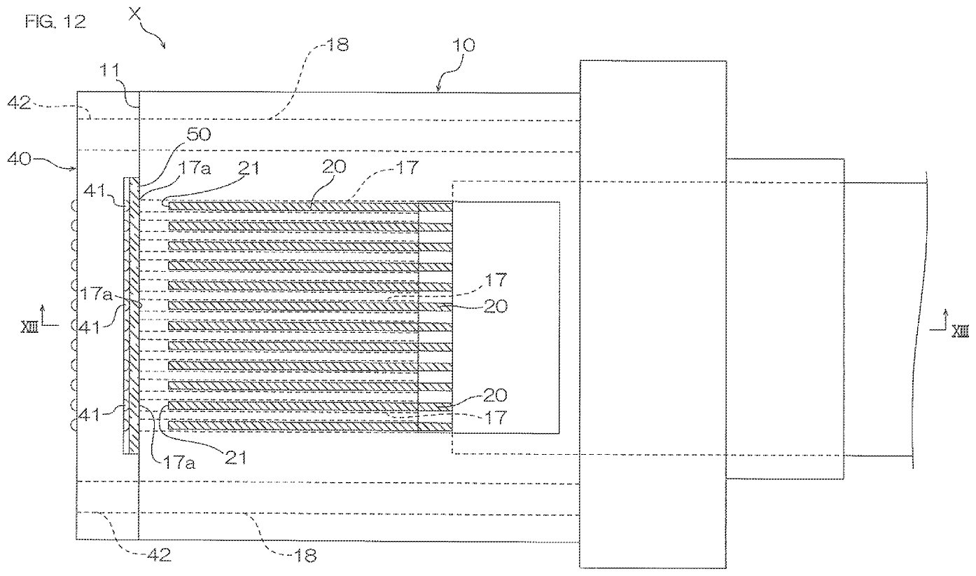

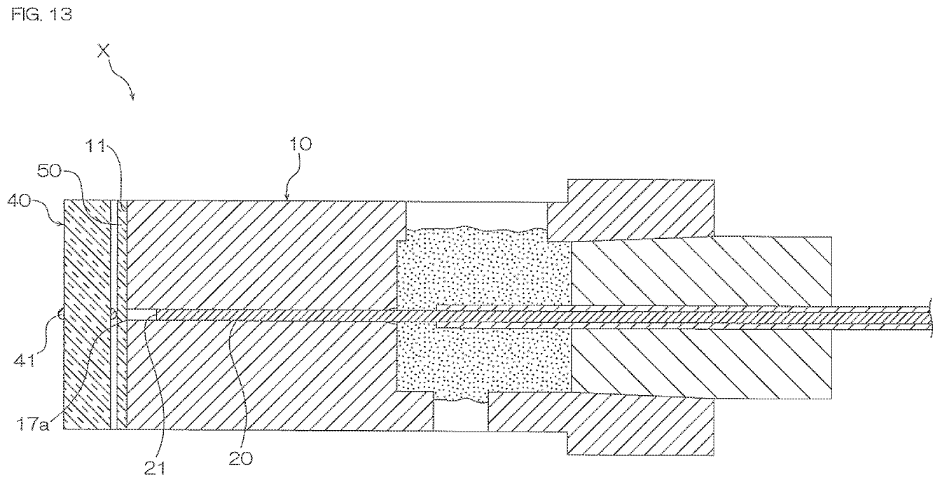

As shown in FIGS. 12 and 13, the optical connector X may include the lens array 40 and the index matching material 50 together (in FIG. 12, the above-described adhesive 30 is omitted).

In this modification, the index matching material 50 is opposed to all the opening ends 17a of the plurality of through holes 17 in the ferrule 10, and the lens portions 41 of the lens array 40 are opposed to the opening ends 17a with the index matching material 50 interposed therebetween. The lens array 40 may be bonded to the leading end face 11 of the ferrule 10 through a predetermined adhesive while the guide hole 18 and the guide hole 42 are aligned with each other, or such adhesive bonding is not made, but the lens array 40 may be assembled with the ferrule 10 by fitting a guide pin (not illustrated) into the guide hole 18 of the ferrule 10 and the guide hole 42 of the lens array 40 as well.

In the optical connector X, the configuration of this modification in which the optical connector X is equipped with the lens array 40 and the index matching material 50 together is suitable for achieving the optical connection between the optical fibers without abutment of their leading ends against each other while suppressing increase in transmission loss.

The optical connector X may have a configuration of a single-core MT connector instead of the configuration of the multi-core MT connector as described above. That is, the optical connector X may be a single-core MT connector provided at one end of a single-core optical fiber cable that constitutes a signal transmission line, and may include a single-core MT ferrule and a single-core optical fiber.

### EXAMPLE

### Example 1

A predetermined ferrule and an optical fiber were prepared and then assembled to produce an optical connector of Example 1. The ferrule is a molded article of polyphenylene sulfide and has a ferrule leading end face and a through hole (diameter: 250 μm) for holding a fiber, the through hole having an opening end in the leading end face. The optical fiber is a refractive index distribution type plastic optical fiber made of polymethyl methacrylate, has a diameter of 250 μm, and has a leading end that is cut out to be flat and perpendicular to the optical axis of the optical fiber.

In the production of the optical connector, first, an optical fiber was inserted into the through hole of the ferrule (fiber insertion step). At this time, the optical fiber was inserted into the through hole so as to retract the leading end of the optical fiber from the ferrule leading end face and while the length of the retraction was adjusted. Then, a first adhesive (a thermosetting epoxy adhesive having a viscosity before curing of 0.3 Pa·s) was supplied into the through hole in which the optical fiber was inserted. Subsequently, the adhesive in the through hole was cured by heating (adhesive curing step). The heating temperature was 100° C. and the heating time was 180 minutes.

In the manner described above, the optical connector of Example 1 was produced. In the optical connector of Example 1, a retracted length L of the optical fiber leading end from the ferrule leading end face was 1 μm. The retracted length L was measured using a laser microscope (trade name “VK-X series”, manufactured by KEYENCE Corporation) (the same applies to other Examples and Comparative Examples).

### Example 2

An optical connector of Example 2 was produced in the same manner as the optical connector of Example 1, except that the retracted length L of the optical fiber leading end from the ferrule leading end face was 10 μm instead of 1 μm.

### Example 3

An optical connector of Example 3 was produced in the same manner as the optical connector of Example 2, except that after the adhesive curing step, a film-shaped index matching material (trade name “Fit Well for optical connector”, 20 μm-thick refractive index matching film, manufactured by Tomoegawa Co., Ltd.) was laminated to the ferrule leading end face through an adhesive in opposed relation to the opening end of the through hole.

### Example 4

An optical connector of Example 4 was produced in the same manner as the optical connector of Example 3, except that a lens portion in opposed relation to the opening end of the through hole was provided on the ferrule leading end face with the index matching material interposed therebetween.

### Example 5

An optical connector of Example 5 was produced in the same manner as the optical connector of Example 4, except that a second adhesive (a thermosetting epoxy adhesive having a viscosity before curing of 1 Pa·s) was used instead of the above-mentioned first adhesive in the production process of the optical connector.

### Comparative Example 1

An optical connector of Comparative Example 1 was produced in the same manner as the optical connector of Example 1, except that in the fiber insertion step, the optical fiber was inserted until the optical fiber leading end reached the ferrule leading end face and then exposed at the ferrule leading end face, the ferrule leading end face and the optical fiber leading end were subjected to polishing treatment using a polisher (trade name “OFL-15”, manufactured by Seikoh Giken Co., Ltd.) and a polishing film (trade name “GISD”, manufactured by Seikoh Giken Co., Ltd.) after the adhesive curing step, and thereafter, distilled water was used as a cleaning solution to clean the polished surface. In the polishing treatment, the processing pressure was 1500 g, the polishing rotation speed was 220 rpm, and the polishing treatment time was 60 seconds.

### Observation of Ferrule Leading End Face

The ferrule leading end face in each of the optical connectors of Examples 1 to 5 and Comparative Example 1 was observed using an optical microscope. The optical connectors of Examples 1 to 4 and Comparative Example 1 showed leakage of the adhesive from the through hole having the optical fiber inserted therein. In contrast to this, the optical connector of Example 5 showed no leakage of the adhesive from the through hole having the optical fiber inserted therein. The optical connectors of Examples 1 to 5 produced without the polishing step showed no contamination due to polishing. In contrast to this, the optical connector of Comparative Example 1 produced in a process including the polishing step showed contamination due to polishing. The ferrule leading end face was observed with a microscope, and when particulate foreign matter originated from the polishing film was present on the ferrule leading end face, it was judged that there was contamination due to polishing, and when such foreign matter was not present, it was judged that there was no contamination due to polishing. These results are shown in Table 1.

### Performance Test of Optical Connector

Optical coupling loss (connection loss) of each of the optical connectors of Examples 1 to 5 and Comparative Example 1 was measured in accordance with JPCA-PE03-01-07S. The results are shown in Table 1. In addition to adhesive contamination, contamination due to polishing also occurred in the optical connector of Comparative Example 1, so that the connection loss was 1.7 dB. In contrast to this, each of the connection loss values in the optical connectors of Examples 1 to 5 was lower than a connection loss of 1.7 dB in the optical connector of Comparative Example 1.

TABLE 1

| | Comparative | Example | Example | Example | Example | Example |
|---|---|---|---|---|---|---|
| | Example 1 | 1 | 2 | 3 | 4 | 5 |
| Retracted length | 0 | 1 | 10 | 10 | 10 | 10 |
| L (μm) | | | | | | |
| Index matching | Not | Not | Not | Provided | Provided | Provided |
| material | provided | provided | provided | | | |
| Lens portion | Not | Not | Not | Not | Provided | Provided |
| | provided | provided | provided | provided | | |
| Viscosity of | 0.3 | 0.3 | 0.3 | 0.3 | 0.3 | 1 |
| adhesive (Pa · s) | | | | | | |
| Contamination | Observed | Not | Not | Not | Not | Not |
| due to polishing | | observed | observed | observed | observed | observed |
| Adhesive | Observed | Observed | Observed | Observed | Observed | Not |
| contamination | | | | | | observed |
| Connection loss (dB) | 1.7 | 1.4 | 1.6 | 1.3 | 0.8 | 0.5 |

### INDUSTRIAL APPLICABILITY

The optical connector of the present invention can be used for optical connection between optical fibers that constitute an optical transmission line in an optical communication network, for example.

### Description of Reference Numerals

X optical connector

10 ferrule

11 leading end face

12 rear end face

13 introduction port

14 hollow portion

15 filling port

16 vent hole

17 through hole

17a, 17b opening ends

18 guide hole

20 optical fiber

21 leading end (fiber leading end)

30 adhesive

40 lens array

41 lens portion

50 index matching material

100 optical fiber cable

1. An optical connector comprising:
a ferrule having a leading end face and a through hole for holding a fiber, the through hole having an opening end in the leading end face; and
a plastic optical fiber having a fiber leading end that is inserted in the through hole and located at a retraction position retracted from the leading end face.

2. The optical connector according to claim 1, wherein a length of the retraction is 1 μm or more and 1000 μm or less.

3. The optical connector according to claim 1, further comprising an index matching material that is opposed to the opening end.

4. The optical connector according to claim 1, further comprising a lens portion that is opposed to the opening end.

5. The optical connector according to claim 1, further comprising an adhesive that is cured to fix the plastic optical fiber in the through hole, the adhesive having a viscosity before curing of 0.5 Pa·s or more and 20 Pa·s or less.

6. The optical connector according to claim 1, wherein the plastic optical fiber is a refractive index distribution type plastic optical fiber.
